(19) United States
(12) Patent Application Publication
(10) Pub. No.: US 2017/0103450 A1
(43) Pub. Date: Apr. 13, 2017

(54) MULTI-FUNCTIONAL AND INTEGRATED ONLINE MARKETPLACE FOR SELLERS AND BUYERS HAVING A REAL-TIME HIGH BIDDER DISPLAY WINDOW

(71) Applicants: Moisses Gonzalez, Brownsville, TX (US); Charles F. Kerby, II, Harlingen, TX (US); Alejandro Trevino, Harlingen, TX (US); Richard Galvan, La Feria, TX (US)

(72) Inventors: Moisses Gonzalez, Brownsville, TX (US); Charles F. Kerby, II, Harlingen, TX (US); Alejandro Trevino, Harlingen, TX (US); Richard Galvan, La Feria, TX (US)

(21) Appl. No.: 14/878,785

(22) Filed: Oct. 8, 2015

(51) Int. Cl. G06Q 30/08; G06Q 40/04

(52) U.S. Cl. CPC G06Q 30/08; G06Q 40/04

(57) ABSTRACT

A method and a computer system for carrying out the method are disclosed including instructions that, when executed, operate an online marketplace facilitating auctions between buyers and sellers in which buyers and sellers remotely communicate with each other in real-time across a server computer in communication with a plurality of client devices. The method includes: initiating a real-time auction of a subject that is at least one of an item and a service; sending real-time display during the auction including a real-time image representing the subject of the auction to multiple client devices during the auction; determining a high real-time bidder from bids sent in real-time from the multiple client devices; and sending video in real-time representing the seller and the high bidder in the form of a screen area showing both the seller and the high bidder.

### FIELD OF THE INVENTION

The present invention relates broadly to online commerce, and more specifically to websites providing online marketplaces.

### BACKGROUND OF THE INVENTION

Numerous online marketplaces have been attempted to facilitate individual transactions between users. Examples include eBay™, Craigslist™, and many others that are found online and are heavily promoted. However, existing online marketplaces have numerous shortcomings.

Current marketplaces such as eBay™ and Craigslist™ provide communication between users, but such communication is limited to proxy emails that conceal user identity while directing email messages to user's registered email addresses, or is limited to a messaging function that operates through a host website in a manner similar to email. Also, there is presently no effective mechanism to enable bartering to enter a bidding auction, allowing only cash payments in auctions in online marketplaces. Finally, auctions in online marketplaces lack personalized excitement because bidders remain faceless, with only a username appearing when a user holds high bidder status.

### SUMMARY OF THE INVENTION

One general aspect of the invention is a method of operating an online marketplace facilitating auctions among buyers and sellers in which buyers and sellers remotely communicate with each other in real-time across a server computer in communication with a plurality of client devices. The method includes: initiating a real-time auction of a subject that is at least one of an item and a service; sending real-time display during the auction including a real-time image representing the subject of the auction to multiple client devices during the auction; determining a high real-time bidder from bids sent in real-time from the multiple client devices; and sending video in real-time representing the seller and the high bidder in the form of a screen area showing both the seller and the high bidder.

In some embodiments, determining the high bidder is an iterative process of comparing bids to a high bid value and reassigning control of the screen area to a new high bidder, until the seller selects a final high bidder, thereby terminating the auction.

In some embodiments, sending video in real-time representing the high bidder includes sending video data received from the high bidder to the multiple client devices.

In some embodiments, sending an image representing the subject includes sending video data generated by the seller in real-time to the multiple devices.

In some embodiments, the method further includes: operating a bidding interface during the auction that includes bids having barter items.

In some embodiments, the method further includes: operating a communication medium between the multiple devices and the seller during the auction.

In some embodiments, operating the communication medium includes at least one of: live chats among users and seller, and seller can post the subject of the auction on social media for sharing.

In some embodiments, operating the communication medium includes sending auction listings by at least one of: email messages, text messages, and third party social media.

In some embodiments, initiating the auction includes displaying to a seller an interface providing controls available to the seller, and representing individual bidders participating in the auction.

In some embodiments, the seller controllably mutes individual bidders.

Another general aspect of the invention is a computer system including instructions that, when executed, operate an online marketplace facilitating auctions between buyers and sellers in which buyers and sellers remotely communicate with each other in real-time across a server computer in communication with a plurality of client devices, by performing steps including: initiating a real-time auction of a subject that is at least one of an item and a service; sending real-time display during the auction including a real-time image representing the subject of the auction to multiple client devices during the auction; determining a high real-time bidder from bids sent in real-time from the multiple client devices; and sending video in real-time representing the seller and the high bidder in the form of a screen area showing both the seller and the high bidder.

In some embodiments, determining the high bidder is an iterative process of comparing bids to a high bid value and reassigning control of the screen area to a new high bidder, until the seller selects a final high bidder, thereby terminating the auction.

In some embodiments, sending video in real-time representing the high bidder includes sending video data received from the high bidder to the multiple client devices.

In some embodiments, sending an image representing the subject includes sending video data generated by the seller in real-time to the multiple devices.

In some embodiments, the steps further include: operating a bidding interface during the auction that includes bids having barter items.

In some embodiments, the steps further include: operating a communication medium between the multiple devices and the seller during the auction.

In some embodiments, operating the communication medium includes at least one of: live chats among users and seller, and seller can post the subject of the auction on social media for sharing.

In some embodiments, operating the communication medium includes sending auction listings by at least one of: email messages, text messages, and third party social media.

In some embodiments, initiating the auction includes displaying to a seller an interface providing controls available to the seller, and representing individual bidders participating in the auction.

In some embodiments, the seller controllably mutes individual bidders.

### BRIEF DESCRIPTION OF THE DRAWINGS

Additional features and advantages of the present invention will become apparent upon reading the following detailed description, when considered in conjunction with the drawings.

FIG. 1 is a block diagram illustrating a website in communication with a plurality of user devices over a communication network.

FIG. 2 is a functional block diagram of the website of FIG. 1.

FIG. 3 is a flow diagram of selling and buying activities facilitated by the website of FIG. 2.

FIG. 4 is a flow diagram of an auction component of the selling and buying activities shown in FIG. 3.

FIG. 5 is a flow diagram of a barter component of the buying and selling activities facilitated by the website of FIG. 2.

FIG. 6 is a registration screen shown to a user that serves as an interface to authenticate and connect users to the website of FIG. 2.

FIG. 7 is a category screen shown to a user from which a user selects a category of items available for selling and buying activities on the website of FIG. 2.

FIG. 8 is a sell screen shown to a user intending to sell an item using the website of FIG. 2.

FIG. 9 is an access screen in which a user gives permission to operators of the website of FIG. 2 to access a user device shown in FIG. 1.

FIG. 10 is a listing creation screen in which a user generates a listing to sell an item on the website of FIG. 2.

FIG. 11 is a screen showing the generated listing that produced by a user operating the screen shown in FIG. 10.

FIG. 12 is a screen showing an alternative embodiment of the generated listing that incorporates a bidder display screen that is active while an item is actively listed for sale on the website of FIG. 2.

FIG. 13 is a screen showing in descending order of value a plurality of barter items listed by the seller and available for selection by bidders.

FIG. 14 is a flow chart showing an operative sequence of steps for an auction in which the high bidder controls a bidder display screen on the auction item listing pages shown in FIGS. 12 and 13.

FIG. 15 is a screen showing an auctioneer's interface for managing communications between multiple bidders.

FIG. 16 is a screen showing an auction participant's interface for communicating with the auction host.

FIG. 17 is a screen showing a user's list of stored item listing pages.

FIG. 18 is a screen showing a plurality of stored item listing pages manipulated by a finger swipe gesture to display individual listing pages in the plurality.

FIG. 19 is a screen showing a list of shared item listing pages maintained by a user.

FIG. 20 is a screen showing a search function for use by a user.

FIG. 21 is a screen showing a filter for limiting the search function of FIG. 20 to a specified geographical radius for listed items.

FIG. 22 is a screen showing a chat function executing between users of the website shown in FIG. 2.

FIG. 23 is a screen showing a video chat version of the chat function shown in FIG. 22.

FIG. 24 is a screen showing a user profile maintained by a user of the website of FIG. 2.

FIG. 25 is a screen showing an offer made by a potential buyer to a user selling an item on the website of FIG. 2.

### DETAILED DESCRIPTION OF THE INVENTION

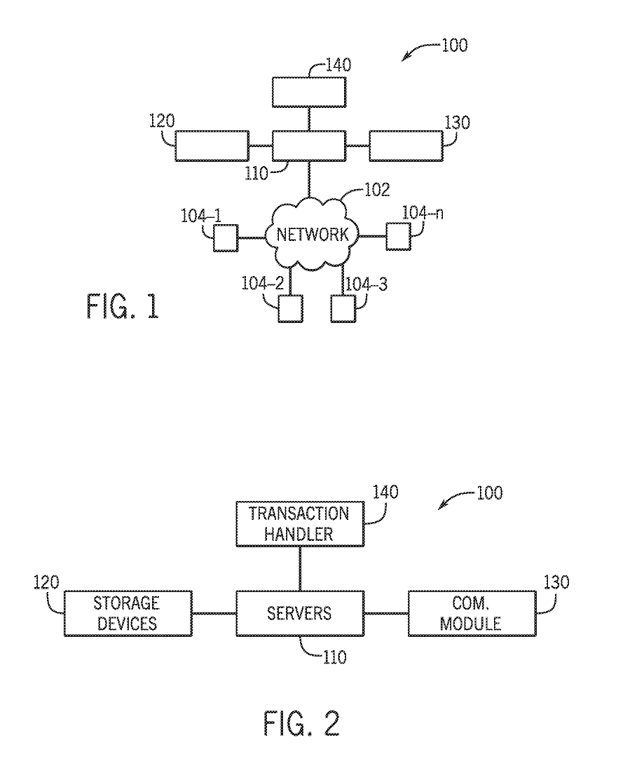

FIG. 1 is a block diagram illustrating a website in real-time communication with a plurality of user devices over a communication network. Website 100 is connected to a communication network 102, such as the Internet, and communicates with individual users connected remotely to network 102 using devices 104. Devices 104 are typically portable devices, such as smart phones and/or tablets, capable of executing computer programs referred to herein as “apps,” obtained from website 100.

FIG. 2 is a functional block diagram of website 100 shown in FIG. 1. Website 100 is typically implemented on a server farm, including a plurality of server computers 110 connected together to function as single computer system. Server computers 110 access storage devices 120 to retrieve and store user information, item listings, sale and bidding data, among other data used in the operation of server computers 110. Server computers also are in communication with communication module 130, which is a specialized network of computers that coordinate real-time communication to and from users of devices 104 and website 100. A specialized server, configured to be a transaction handler 140, may also be provided to facilitate payments between users and access to third party payment facilities such as Paypal™.

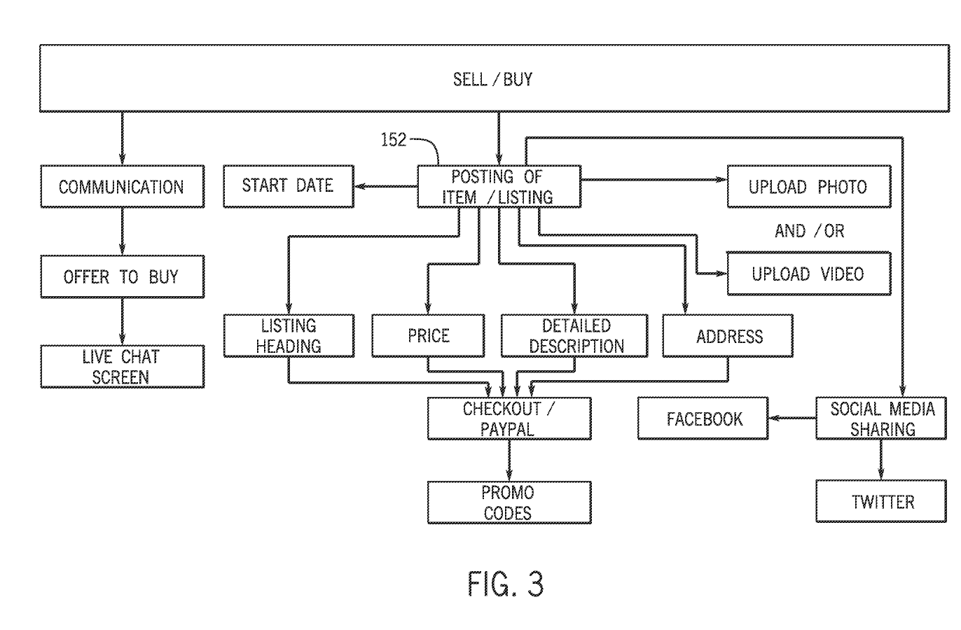

FIG. 3 is a flow diagram 150 of selling and buying activities facilitated by the website of FIG. 2. Website 100 facilitates trade between buyers and sellers in the form of item listings that include information such as listing heading, price, detailed description, address, and the like. Communication between users such as offers to buy, live chat between users, social media sharing of item listings, and the like is also provided. Users may upload photos and/or video, and share listings by email, text, or third party social media such as Facebook™ or Twitter™. When a purchase transaction is performed, transaction handler 140 (FIG. 2) facilitates payment by interfacing a user with a payment system such as provided by Paypal™.

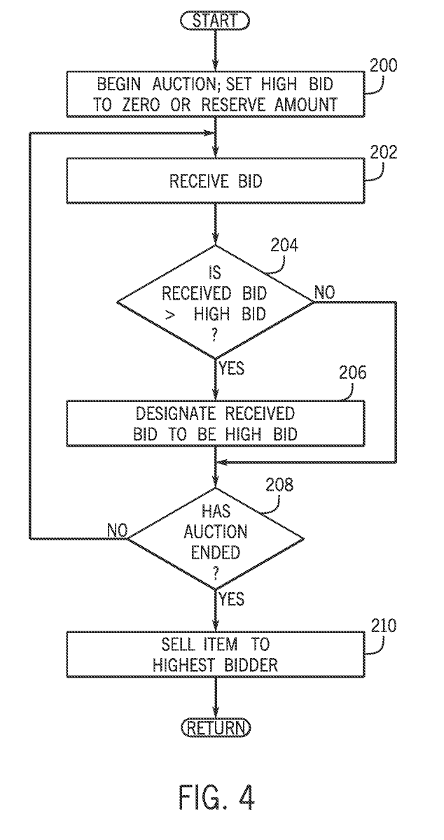

FIG. 4 is a flow diagram of an auction component of the selling and buying activities shown in FIG. 3. When an item (or service) is listed for sale in an auction format on website 100, the auction process begins at step 200 at a time specified by the seller, with either a high bid set to zero or a reserve amount that must be met by a bidder in order to buy the item. Users of devices 104 (FIG. 1) viewing in real-time an item listing contained in an auction are allowed to bid on the item. When a bid is received at step 202, it is compared against the high bid at comparison step 204, and, if the bid is for more than the existing high bid value, at step 206 the bid amount is designated as the high bid. At decision step 208, if the auction time has ended, control transitions to step 210, where the item is sold to the bidder placing the current high bid. In an embodiment, the high bid is not the entire amount bid by a user, but rather an increment higher than the previous high bid; for example, if the high bid is $100 and a bidder places a bid for $150, the bidders high bid is not $150 but a lesser amount, such as $102.50. In another embodiment, the high bid is shown as the full bid amount of $150.

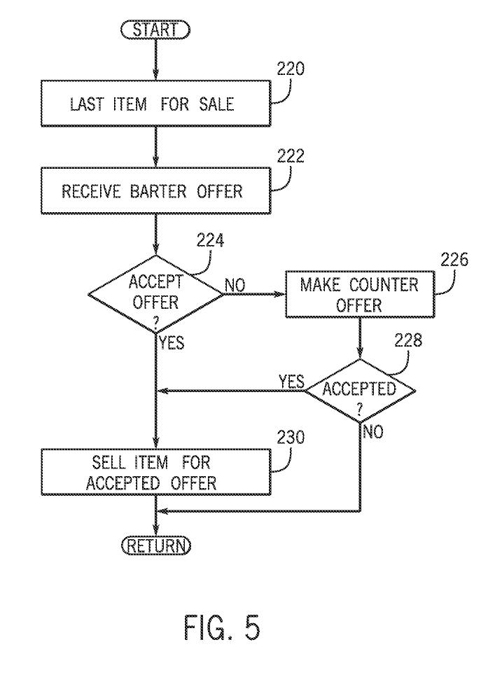

While FIG. 4 illustrates embodiments using cash bidding in auctions, website 100 also facilitates sale of items through barter. FIG. 5 is a flow diagram of a barter component of the buying and selling activities facilitated by the website of FIG. 2. At step 220, a listing of an item becomes active, either by auction or regular sale for a set price or invitation to barter. At step 222, the user selling the item listed receives a barter offer from another user. At comparison step 224, the user selling the item can either accept the offer or reject the offer and make a counteroffer to the prospective buyer at step 226. At step 228, the counter offer is accepted by the prospective buyer. At step 228, whichever offer is accepted becomes the sale price, and the item is sold for that amount.

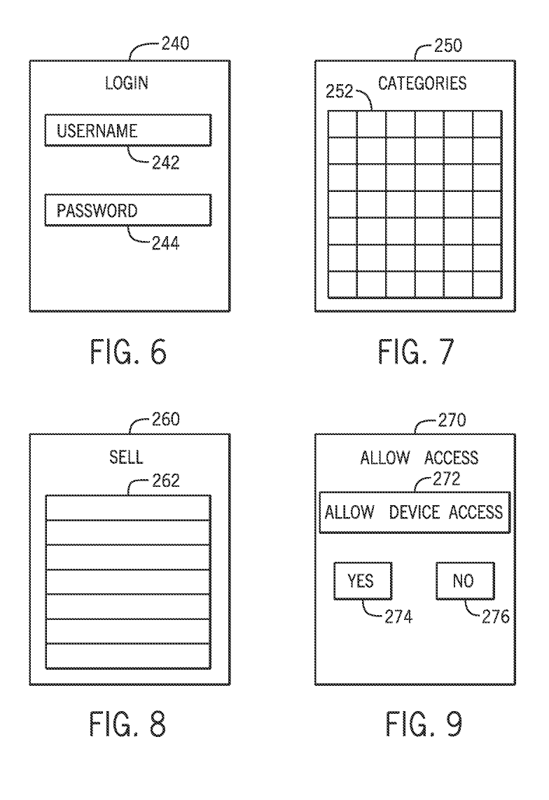

FIG. 6 is a registration screen 240 shown to a user that serves as an interface to authenticate and connect users to the website of FIG. 2. Screen 240 is presented to a user of device 104 (FIG. 1) whenever a connection is established between user device 104 and website 100 over network 102. By authenticating users as they establish connection to website 100, a measure of trust is provided between buyers and sellers using website 100.

FIG. 7 is a category screen 250 shown to a user from which a user selects a category of items available for selling and buying activities on the website of FIG. 2. Individual categories can be presented using icons, such as icons 252 depicting categories of items, such as motors, fashion, electronics, collectibles & art, home & garden, sporting goods, toys & hobbies, deals & gifts, and the like.

FIG. 8 is a sell screen shown 260 to a user intending to sell an item using the website of FIG. 2. By presenting multiple items for sale in a list format 262, a seller can quickly and easily manage multiple sale listings from a single screen. Screen 260 can include high bid amounts for current auction items, as well as barter offers received in auctions and straight sale listings.

FIG. 9 is an access screen 270 in which a user gives permission to operators of the website of FIG. 2 to access a user device 104 shown in FIG. 1. When connected to website 100, a user of device 104 can be presented with a request by website 100 to allow website 100 to remotely access an aspect of the user's device 104, such as location information, or control a component of user device 104, such as a camera operating on user device 104. The user is presented with the request for access in display 272, and has a choice of denying the request (button 274) or granting the request (button 276).

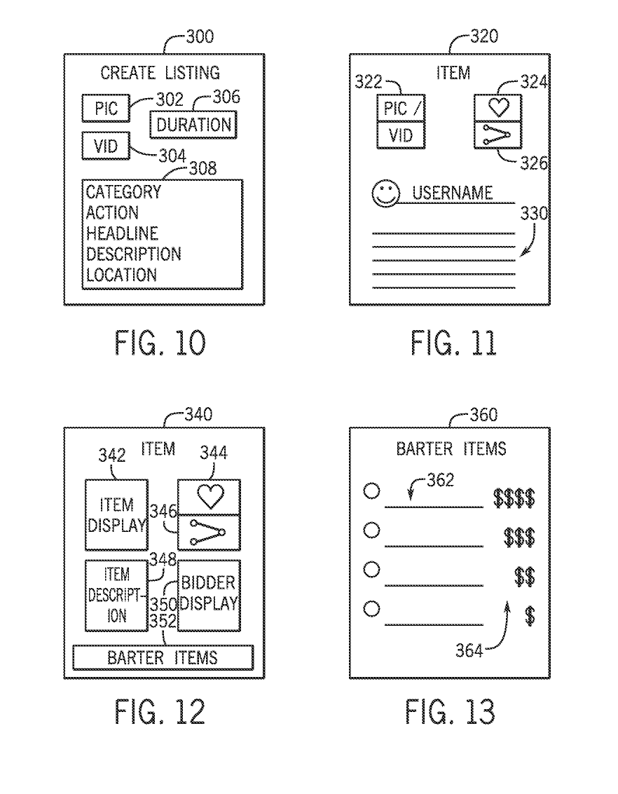

FIG. 10 is a listing creation screen 300 in which a user generates a listing to sell an item on the website of FIG. 2. An item listing includes a visual representation of the item for sale, such as photographs 302 and/or video 304, supplied by the user generating the listing by uploading images and/or video to website 100. A duration 306 may also be specified by the user generating the listing, as well as other information 308, which may include items such as category, action regarding sale of the item, headline, description, and location.

When uploading video, a user selects to either record a new video or choose an existing video from a camera roll or video library. A request is sent from user device 104 to communication module 130 (FIG. 1), along with a user identifier and an item listing identifier. A video identifier is created by communication module 130, and associated with the video received from the user. The video, and its identifier, as well as the user identifier and item listing identifier, are stored in storage devices 120. Server 110 then returns the video identifier to the user uploading it, along with a status message and code that indicate success or failure of uploading the video.

FIG. 11 is a screen showing the generated listing 310 that is produced by a user operating screen 300 shown in FIG. 10. Item listing 320 includes an image display 322 for images and video, a favorites button 324 that places item listing into a user's favorites list, and a share button 326 that allows a viewer of listing 310 to share the listing with others through a variety of communication methods, such as social media, text, email, and the like. User icon 328 indicates the seller of the item listed. Additional information, such as item description, terms of sale, and the like, are shown in display area 330.

FIG. 12 is a screen showing an alternative embodiment of the item listing 340 that incorporates similar elements of item listing 320, such as item display 342, favorite button 244 and share button 346, and item description 348, but also adds a bidder display screen 350 that is active in real-time while an item is actively listed for sale on the website of FIG. 2 and controllable by the prospective buyer or high bidder during an auction. In a further embodiment, barter items button 352, when selected, presents a barter screen 360 (FIG. 13) that incorporates a list 362 of barter items in screen. As shown in FIG. 13, screen 360 shows in descending order of value 362 a plurality of barter items listed by the seller and available for selection by bidders.

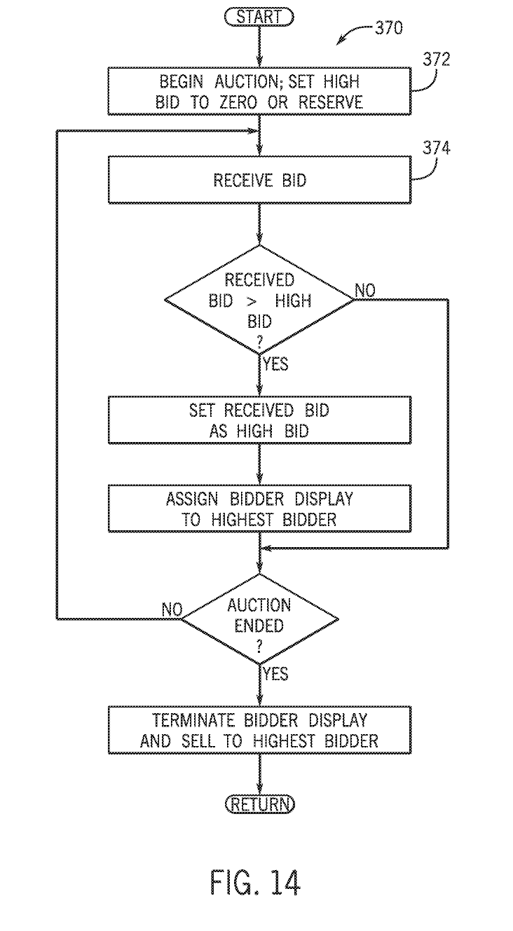

FIG. 14 is a flow chart showing an operative sequence of steps 370 for an auction in which the high bidder controls a bidder display screen in real-time on the auction item listing pages shown in FIGS. 12 and 13. When an auction begins at step 372, an item listing becomes active and bidding is opened. High bid is set to zero or a reserve amount set by the seller. At step 374, a bid is received from a user of device 104. At comparison step 376, if the received bid is greater than the high bid, control transitions to step 378 and the received bid is set as the high bid. If the bid received is not greater than the high bid, control transitions to step 382, where a determination is made as to whether the auction has ended. If the auction is still active, control returns to step 374 when another bid is received. At step 380, the user submitting the high bid is awarded control of bidder display space 350 on item listing 340 (FIG. 12). The high bidder thus enjoys a status over other users, and use bidder display space to display an image, an icon, a video, a message, play music, or whatever else the high bidder desires to show the reset of the users viewing item listing 340.

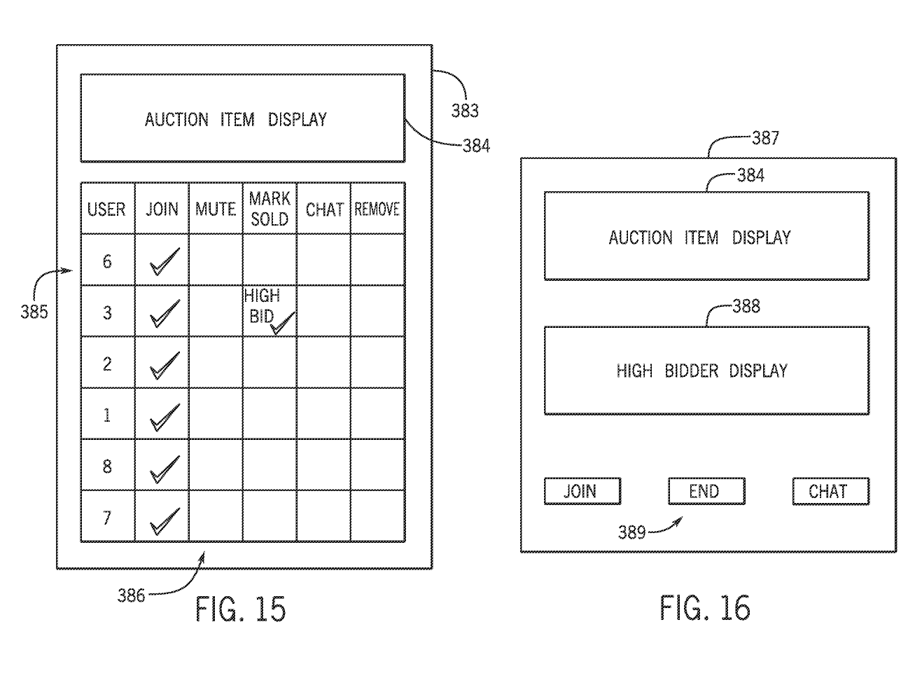

FIG. 15 is a screen showing an auctioneer's interface 383 for managing communications between multiple bidders during an auction for an item for sale in auction item display 384. Display 384 shows photographs or video associated with the item being auctioned. As multiple participants choose to join an auction as potential bidders, they are assigned identifiers 385 and the user auctioning an item is presented with a plurality of controls 386 for each participant having an identifier 385. In an embodiment, included controls are a join button, which grants permission to a user to join an auction, a mute button to silence any audio from the user, a “mark sold” button to designate a buyer, a chat button to enable direct communication with the user, and a remove button to disconnect a user from the auction. In embodiments, the chat button can instantiate a text chat, or a voice chat between seller and an individual potential bidder.

FIG. 16 is a screen showing an auction participant's interface 387 for communicating with the auction host (who is presented with interface 384 in FIG. 15). As shown, a user viewing an item being auctioned is presented with an auction item display window 384, which, as described above in FIG. 15, shows photographs or video of the item being auctioned in real-time, and may be accompanied any audio, including real-time audio. High bidder display window 388 is dedicated to a current high bidder in the auction of the item shown in auction item display window 384. Additional controls 399 include a join button that connects the participant to the user auctioning the item in a request to be admitted as a potential bidder, an end button to remove oneself from the pool of potential bidders to which he or she was admitted after selecting the join button, and a chat button that initiates a chat with the auctioning user or other user as well as responds to any received chat requests.

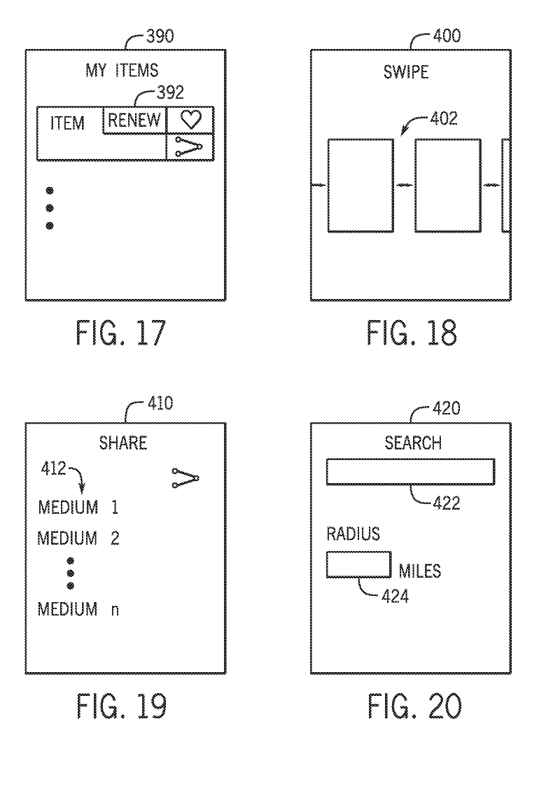

FIG. 17 shows screen 390 displaying a user's list of stored item listings 320 (FIG. 11) and 340 (FIG. 14). By selecting the favorites button 322 or 342 on item listings shown to the user, a user generates a collection of item listings 392 in an organized format that presents a selectable list to the user.

FIG. 18 shows a screen 400 displaying a plurality of stored item listing pages 402 that are manipulated by a finger swipe gesture to display individual listing pages in the plurality. By dragging a finger across a touch screen, the user can sort through a group of item listings quickly and select them individually for larger display.

FIG. 19 shows screen 410 displaying list 412 of shared item listing pages maintained by a user. When a user shares a listing page 320 or 340 (FIGS. 11 and 14) by pressing the share button 324 or 344, list 412 is updated to add the shared listing and provide an indication of which medium (text, email, social media) was used to share the item listing with another user known to the user maintaining list 412.

FIG. 20 shows search screen 420 providing a search function to a user of device 104 connected to website 100 through network 102. Search strings are entered in window 422, and optionally, geographical distance may be limited to a radius from the user as specified by the user in distance box 424.

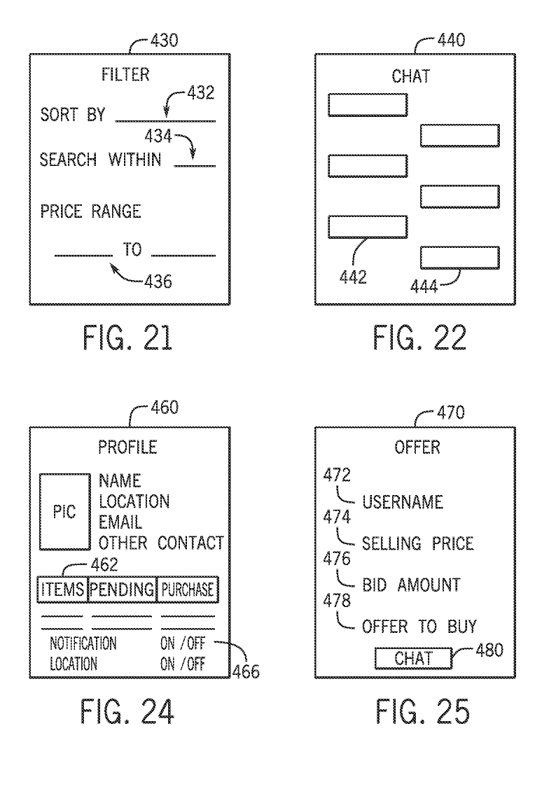

FIG. 21 shows filter screen 430 that places limits on search results returned by the search function shown in FIG. 20 to organize it based on sorted results parameter 432, such as price, distance, time ending, time listed, and the like. Search parameter 434 allows a user to direct a search to specific category. Price range parameter 436 allows a user to specify a minimum and maximum sale price.

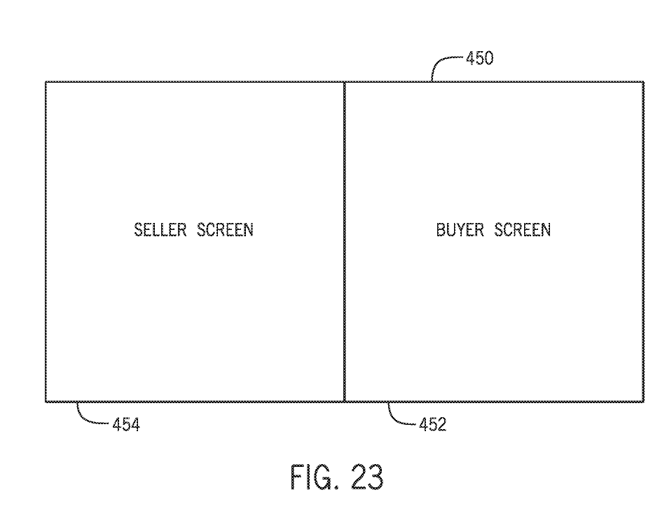

FIG. 22 shows chat screen 440 showing a chat function executing between users 442 and 444. In an embodiment, chat screen 440 allows unrestricted communication in real-time between users 442 and 444. While chat screen 440 allows written communication between users, an embodiment of the present invention replaces this form with video chat (FIG. 23) in which video chat screen 450 displays two screens on each of users 442 and 444 device 104. Buyer screen 452 and seller screen 454 typically contains real-time video and audio of the two users, and thus utilizes devices typically found on devices 104, such as a microphone, speaker and camera that is streamed over network 102 to website 100 or directly to other users of devices 104.

Along with the login name and password to provide a measure of trust between users of website 100, user profiles are displayed to other users when selected from item listings 320 and 340. FIG. 24 shows user profile screen 460 showing a user profile maintained by a user of the website of FIG. 2. Items 462 on profile screen 460 may include user name, image, location, email address or other contact information, items representing the user shown in the profile, and selectable button 466 for notifications, allowing the user in the profile to selectively turn on or off a notifications option, as well as selectable button 468 that allows the user shown in the profile to either display or conceal his or her location.

Notifications button 466 controls the push notification feature of website 100. When enabled by the user, website 100 employs notification services to send messages to users of device 104. Typically, items that are associated with items previously viewed by the user are pushed in notifications to the user. Activating notifications button 466 causes website 100 to issue a unique token to user device 104. When an action occurs on website 100, for example, the creation of an item listing that is associated with items previously viewed by a user, for example by category or geographical location, a push notification is issued to the user with an activated notifications button 466. Additional triggers for push notifications can include a user placing a bid on an item, sending a chat message, selling an item, and the like.

FIG. 25 shows offer screen 470 showing an offer made by a potential buyer to a user selling an item on the website of FIG. 2. As shown, an offer is generated by a prospective buyer by selecting item listing 320 or 340, which imports the username from the seller listed in the item listing, as well as the selling price. A user making an offer can enter a bid term 476 (dollar amount or barter offer) for auction style listings, or an offer to buy term 478, also in the form of a dollar amount or a barter offer. When the user presses chat button 480, offer screen 470 is presented to user listed under username 472, and, if the seller is interested, he or she may accept a chat request and negotiate a sale with the user presenting the offer.

The auction ends when the seller selects a high bidder as a final high bidder (also call the highest bidder), or when a time limit is reached, in which case the current high bidder becomes the final high bidder (highest bidder). The seller then decides whether to accept that high bid from the final high bidder.

While a method and system for an integrated, interactive, and multi-functional online marketplace has been illustrated and described in detail in various preferred embodiments, it is to be understood that numerous modifications can be made to present invention without departing from the spirit thereof.

What is claimed is:

1. A method of operating an online marketplace facilitating auctions among buyers and sellers in which buyers and sellers remotely communicate with each other in real-time across a server computer in communication with a plurality of client devices, the method comprising:
initiating a real-time auction of a subject that is at least one of an item and a service;
sending real-time display during the auction including a real-time image representing the subject of the auction to multiple client devices during the auction;
determining a high real-time bidder from bids sent in real-time from the multiple client devices; and
sending video in real-time representing the seller and the high bidder in the form of a screen area showing both the seller and the high bidder.

2. The method of claim 1, wherein determining the high bidder is an iterative process of comparing bids to a high bid value and reassigning control of the screen area to a new high bidder, until the seller selects a final high bidder, thereby terminating the auction.

3. The method of claim 1, wherein sending video in real-time representing the high bidder includes sending video data received from the high bidder to the multiple client devices.

4. The method of claim 1, wherein sending an image representing the subject includes sending video data generated by the seller in real-time to the multiple devices.

5. The method of claim 1, further comprising:
operating a bidding interface during the auction that includes bids having barter items.

6. The method of claim 1, further comprising:
operating a communication medium between the multiple devices and the seller during the auction.

7. The method of claim 6, wherein operating the communication medium includes at least one of: live chats among users and seller, and seller can post the subject of the auction on social media for sharing.

8. The method of claim 6, wherein operating the communication medium includes sending auction listings by at least one of: email messages, text messages, and third party social media.

9. The method of claim 1, wherein initiating the auction includes displaying to a seller an interface providing controls available to the seller, and representing individual bidders participating in the auction.

10. The method of claim 9, wherein the seller controllably mutes individual bidders.

11. A computer system including instructions that, when executed, operate an online marketplace facilitating auctions between buyers and sellers in which buyers and sellers remotely communicate with each other in real-time across a server computer in communication with a plurality of client devices, by performing steps comprising:
initiating a real-time auction of a subject that is at least one of an item and a service;
sending real-time display during the auction including a real-time image representing the subject of the auction to multiple client devices during the auction;
determining a high real-time bidder from bids sent in real-time from the multiple client devices; and
sending video in real-time representing the seller and the high bidder in the form of a screen area showing both the seller and the high bidder.

12. The computer system of claim 11, wherein determining the high bidder is an iterative process of comparing bids to a high bid value and reassigning control of the screen area to a new high bidder, until the seller selects a final high bidder, thereby terminating the auction.

13. The computer system of claim 11, wherein sending video in real-time representing the high bidder includes sending video data received from the high bidder to the multiple client devices.

14. The computer system of claim 11, wherein sending an image representing the subject includes sending video data generated by the seller in real-time to the multiple devices.

15. The computer system of claim 11, further comprising:
operating a bidding interface during the auction that includes bids having barter items.

16. The computer system of claim 11, further comprising:
operating a communication medium between the multiple devices and the seller during the auction.

17. The computer system of claim 16, wherein operating the communication medium includes at least one of: live chats among users and seller, and seller can post the subject of the auction on social media for sharing.

18. The computer system of claim 16, wherein operating the communication medium includes sending auction listings by at least one of: email messages, text messages, and third party social media.

19. The computer system of claim 11, wherein initiating the auction includes displaying to a seller an interface providing controls available to the seller, and representing individual bidders participating in the auction.

20. The computer system of claim 19, wherein the seller controllably mutes individual bidders.
